(19) United States
(12) Patent Application Publication
(10) Pub. No.: US 2013/0016967 A1
(43) Pub. Date: Jan. 17, 2013

(54) OPTICAL PACKET SWITCHING APPARATUS

(71) Applicant: Reiko Sato, Kawasaki-shi (JP)

(72) Inventor: Reiko Sato, Kawasaki-shi (JP)

(21) Appl. No.: 13/528,722

(22) Filed: Jun. 20, 2012

(30) Foreign Application Priority Data
Jul. 12, 2011 (JP) 2011-154091

(51) Int. Cl. H04B 10/08

(52) U.S. Cl. 398/26

(57) ABSTRACT

An optical packet switching apparatus includes an optical switch unit for switching the route of an optical packet signal, an OSNR acquiring unit for obtaining the information on the optical-to-noise ratio (OSNR) of the optical packet signal, and a regenerative relay unit for regenerating and relaying the optical packet. When the OSNR of the optical packet signal is less than a predetermined reference value, the optical switch unit outputs the optical packet signal to the regenerative relay unit. The regenerative relay unit sends back the regenerated optical packet to a route through which the optical packet is supposed to be sent out.

### BACKGROUND OF THE INVENTION

1. Field of the Invention

The present invention relates to an optical packet switching apparatus that enables packet switching for each optical.

2. Description of the Related Art

In optical transmission systems employing wavelength division multiplexing (WDM), a technique that performs the path switching per wavelength by the use of a wavelength selective switch (WSS) and the like is put to practical use. As a technology that may succeed this technique, an optical packet switching method is now being investigated. In this optical packet switching method, an IP packet (10 GEther (10 Gigabit Ethernet (registered trademark) signal and the like), for example, is used as a small unit with which the switching is performed, and each is converted into the form of an optical packet and then the route is switched by an ultrahigh-speed optical switch (see Reference (1) in the following Related Art List, for instance).

The IP packet does not transfer any significant information in the absence of data therein, so that the bandwidth corresponding thereto is wasted. However, if the optical packet switching system is realized, then the time slot of a packet where data is absent can be occupied by another packet. Therefore, the optical packet switching system is considered a promising technology of the future which is capable of markedly enhancing the bandwidth usage efficiency of the transmission path.

### RELATED ART LIST

(1) Japanese Unexamined Patent Application Publication No. 2008-235986.

In the optical packet switching scheme, a destination address is attached to each optical packet, and the optical packets are transferred as they are switched by a plurality of optical packet switching apparatus according to the destinations. Thus, optical packets arriving at a certain optical packet switching apparatus have passed through different routes from various transmitting stations, and therefore these optical packets have varied optical signal-to-noise ratios (OSNRs), respectively. The destination of the optical packets whose OSNR has been degraded cannot be detected and therefore those optical packets may not be properly switched. Also, the bit error rate of an optical packet may be degraded at a receiving station to which the optical packet is addressed.

### SUMMARY OF THE INVENTION

The present invention has been made in view of the foregoing circumstances, and a purpose thereof is to provide an optical packet switching apparatus capable of improving the signal-to-noise ratio.

In order to resolve the above-described problems, an optical packet switching apparatus according to one embodiment of the present invention includes: an optical switch unit configured to switch a route of an inputted optical packet signal; an optical signal-to-noise ratio (OSNR) acquiring unit configured to acquire information on an optical signal-to-noise ratio of the optical packet signal; and a regenerative relay unit configured to regenerate and relay the optical packet. When the optical signal-to-noise ratio of the optical packet signal is less than a predetermined reference value, the optical switch unit outputs the optical packet signal to the regenerative relay unit.

The regenerative relay unit may convert the inputted optical packet signal into an electrical signal, perform equalization and amplification, timing extraction, and identification and regeneration on the electrical signal, and again convert the regenerated electrical signal into an optical packet signal to be outputted.

The regenerative relay unit may send back the regenerated optical packet signal to a route through which the optical packet signal is supposed to be transmitted.

The regenerative relay unit may send back the regenerated optical packet signal to an input of the optical switch unit.

Optional combinations of the aforementioned constituting elements, and implementations of the invention in the form of methods, apparatuses, systems, programs, recording media storing the programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is a diagram showing an optical packet switching apparatus according to an embodiment of the present invention;

FIG. 2 is an optical packet switching apparatus according to another embodiment of the present invention;

FIG. 3 is a diagram for explaining a structure of an optical switch unit;

FIG. 4 is a diagram for explaining a processing flow of an optical switch unit;

FIG. 5 is a diagram for explaining another processing flow of an optical switch unit; and

FIG. 6 is a diagram for explaining a structure of a regenerative relay unit.

### DETAILED DESCRIPTION OF THE INVENTION

The invention will now be described by reference to the preferred embodiments. This does not intend to limit the scope of the present invention, but to exemplify the invention.

Embodiments of the present invention will be hereinbelow described with reference to Drawings.

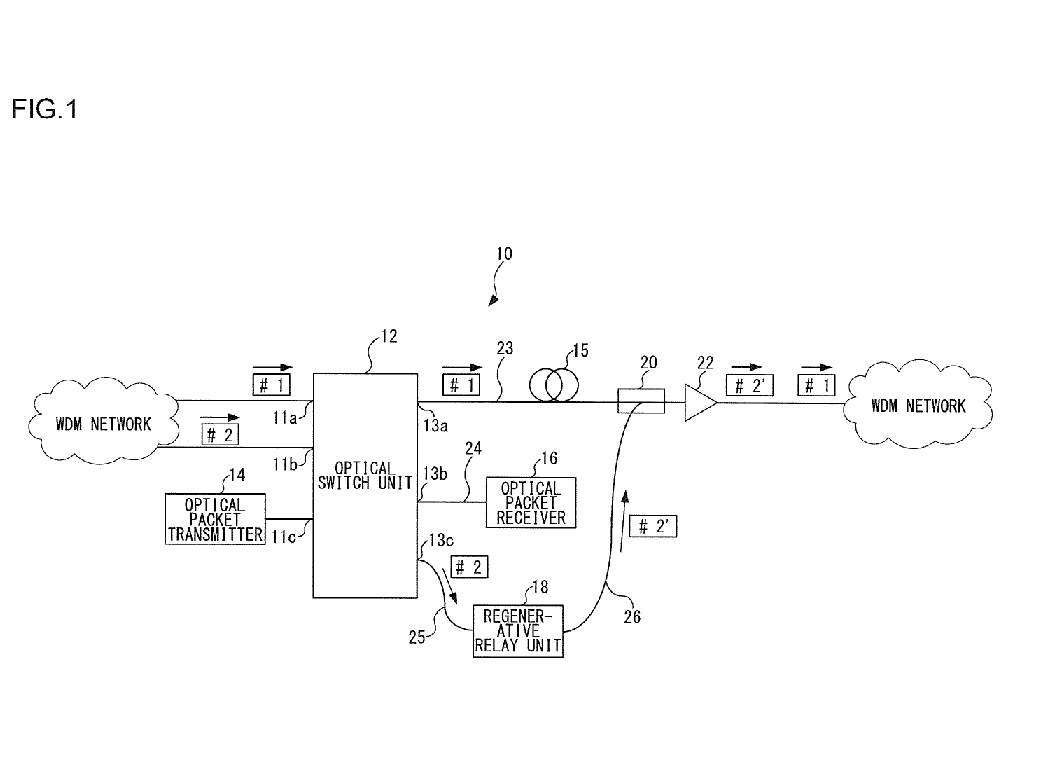

FIG. 1 is a diagram showing an optical packet switching apparatus 10 according to an embodiment of the present invention. As shown in FIG. 1, the optical packet switching apparatus 10 includes an optical switch unit 12, an optical packet transmitter 14, an optical packet receiver 16, a regenerative relay unit 18, an optical coupler 20, and an optical amplifier 22.

An optical signal-to-noise ratio (OSNR) acquiring unit 32 receives client signals from a client side. Then the OSNR acquiring unit 32 appends destination information, packet length information and the like to the client signal, thereby generates an optical packet signal, and sends the thus generated optical packet signal to the optical switch unit 12.

The optical switch unit 12 is an optical switching device, with N inputs×N outputs, which switches the route of the inputted optical packet signals. The optical packet signals sent from a WDM network are inputted to a first input port 11a and a second input port 11b. An optical packet signal sent from the optical packet transmitter 14 is inputted to a third input port 11c.

The optical switch unit 12 switches the path of the inputted optical packet signals and outputs them from first to third output ports 13a to 13c. The optical packet signal outputted from first output port 13a of the optical switch unit 12 is inputted to an optical amplifier 22 via a first optical fiber 23. After amplifying the inputted optical packet signal, the optical amplifier 22 sends out the amplified optical packet signal to the WDM network. Also, the optical packet signal outputted from the second output port 13b of the optical switch unit 12 is inputted to the optical packet receiver 16 via a second optical fiber 24. The optical packet receiver 16 restores the received optical packet signal to the original client signal and then outputs the restored signal to the client side. Also, the optical packet signal outputted from the third output port 13c of the optical switch unit 12 is inputted to the regenerative relay unit 18 via a third optical fiber 25.

In the present embodiment, the optical switch unit 12 has a function of measuring the optical signal-to-noise ratio (OSNR) of an optical packet signal. Then the optical switch unit 12 determines an output port from which the optical packet signal is to be outputted, based on not only the destination information extracted from the optical packet signal but also the OSNR of the optical packet signal.

More specifically, when the OSNR of the optical packet signal is greater than or equal to a predetermined reference value, the optical switch unit 12 determines either the first output port 13a or the second output port 13b according to the destination information. When, on the other hand, the OSNR thereof is less than the reference value, the optical switch unit 12 outputs the optical packet signal from the third output port 13c. The reference value may be set to a value, which is the minimum OSNR allowable by a receiver (e.g., the optical packet receiver 16) receiving the optical packet, or above.

For the purposes of explanation, FIG. 1 illustrates how a first optical packet signal #1 is inputted to the first input port 11a from the WDM network and, subsequently, a second optical packet signal #2 is inputted to the second input port 11b therefrom. Assume herein that the first optical packet signal #1 has an OSNR which is greater than or equal to the reference value and assume also that the second optical packet signal #2 has an OSNR which is less than the reference value. Also, assume herein that the destination of the first optical packet signal #1 and the second optical packet signal #2 is another optical packet switching apparatus connected to the WDM network and they are optical packets to be outputted from the first output port 13a when the route thereof is determined based on the destination information only.

In such a case, since the OSNR of the first optical packet signal #1 is greater than or equal to the reference value, the optical switch unit 12 outputs the first optical packet signal #1 from the first output port 13a, based on the destination information. Then, the first optical packet signal #1 is inputted to the optical amplifier 22 via the first optical fiber 23 and is amplified by the optical amplifier 22 so as to be sent out to the WDM network.

On the other hand, since the OSNR of the second optical packet signal #2 is less than the reference value, the optical switch unit 12 outputs the second optical packet signal #2 from the third output port 13c, regardless of the destination information. In other words, the optical switch unit 12 outputs the second optical packet signal #2 to the regenerative relay unit 18 instead of to the first optical fiber 23 that is the path, to which the second optical packet signal #2 is otherwise supposed to be outputted, based on the destination information.

The regenerative relay unit 18 converts the inputted second optical packet signal #2 into an electrical signal, then performs equalization and amplification (Reshaping), timing extraction (Retiming), and identification and regeneration (Regenerating) on the electrical signal, and again converts the regenerated electrical signal into an optical packet signal so as to be outputted. These processes are called “3R's regenerative relays”. The OSNR of the second optical packet signal #2 after the 3R's processes becomes greater than or equal to the reference value. The thus regenerated second optical packet signal #2′ is sent back, via a fourth optical fiber 26, to the path to which the second optical packet signal #2 is otherwise supposed to be outputted. That is, the regenerated second optical packet signal #2′ is inserted into the first optical fiber 23 by the optical coupler 20. After this, the regenerated second optical packet signal #2′ is inputted to the optical amplifier 22 and is amplified by the optical amplifier 22 so as to be sent out to the WDM network.

As described above, when an optical packet signal whose OSNR is below the reference value is inputted, the optical packet switching apparatus 10 according to the present embodiment can not only switch the route but also regenerate the optical packet signal and output it. As a result, the OSNR of the optical packet signal outputted from the optical packet switching apparatus 10 can be kept at the reference value or above.

In the optical packet switching scheme, an optical packet signal normally passes through a plurality of optical packet switching apparatuses before it reaches a receiving station, and the OSNR gets degraded due to the optical amplifier every time the optical packet signal passes through each of the plurality of optical packet switching apparatuses. Thus, even though the optical packet signal has a satisfactory OSNR, at a transmitting station, which is equal to or above the reference value, the OSNR may degrade as the optical packet signal passes through many relay apparatuses each having an optical packet switching apparatus and an optical amplifier. As a result, the optical packet signals may not be properly switched because of inability to detect the destination information. Also, the bit error rate of the optical packet signal may be degraded at a receiving station to which the optical packet is addressed. By employing the optical packet switching apparatus 10 according to the present embodiment, however, the OSNR is improved every time the optical packet signal passes through each optical packet switching apparatus. Hence, the optical packet signals can be properly switched and the deterioration of the bit error rate thereof can be suppressed.

In the present embodiment, the optical packet signal that has passed through the regenerative relay unit 18 is delayed by the time duration required for the 3R's processes carried out at the regenerative relay unit 18. Because of this delay, it is possible that congestion occurs between the optical packet signal sent back to the first optical fiber 23 and a subsequent optical packet signal. In the light of this, an optical delay line 15 is provided between the first output port 13a of the optical switch unit 12 and the optical coupler 20. With provision of the optical delay line 15, an adjustment is made so that the time it takes for the optical packet signal to reach the optical coupler 20 from the first output port 13a and the time it takes for the optical packet to reach the optical coupler 20 from the third output port 13c via the regenerative relay unit 18 be identical to each other.

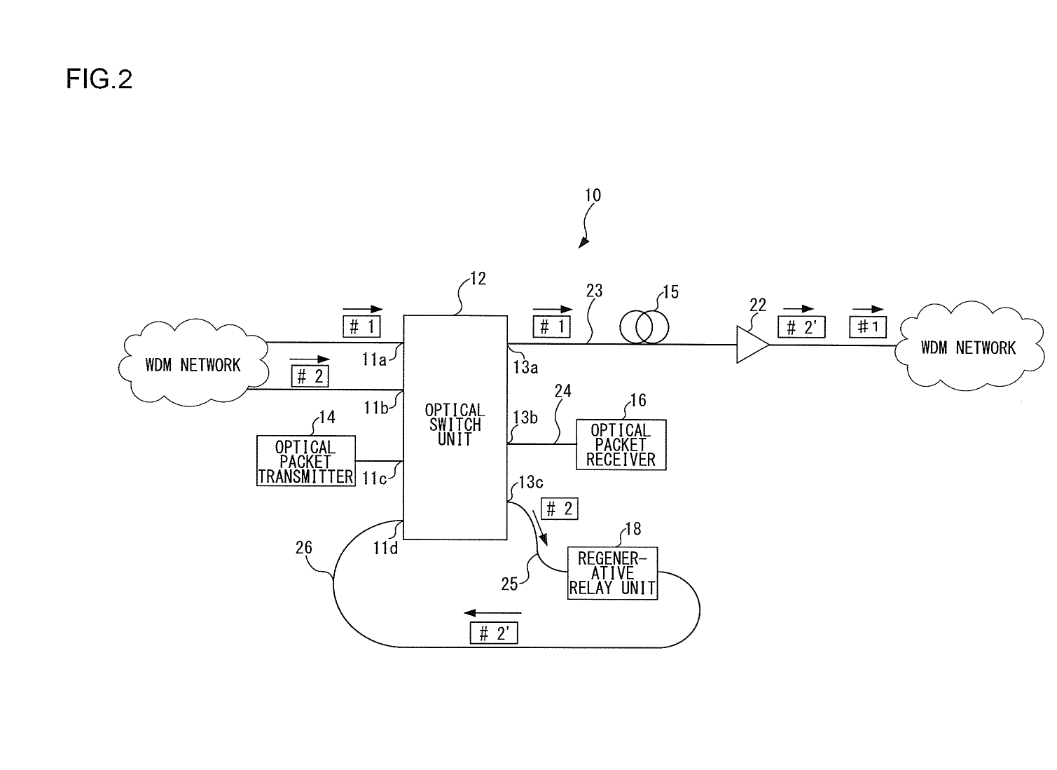

FIG. 2 is an optical packet switching apparatus 10 according to another embodiment of the present invention. Components of the optical packet switching apparatus 10 according to the present embodiment shown in FIG. 2, which are identical to or correspond to those of the optical packet switching apparatus 10 shown in FIG. 1, are given the same reference numerals herein and the repeated description thereof are omitted as appropriate.

As shown in FIG. 2, in the optical packet switching apparatus 10, the output of the regenerative relay unit 18 is connected to a fourth input port 11d of the optical switch unit 12 via the fourth optical fiber 26. Thus, the second optical packet signal #2′ regenerated by the regenerative relay unit 18 is inputted to the fourth input port 11d of the optical switch unit 12.

The optical switch unit 12 processes the second optical packet signal #2′ inputted to the fourth input port 11d; this processing performed here is the same as that performed on the optical packet signals inputted to the first input port 11a and the second input port 11b. That is, the destination information of the second optical packet signal #2′ is extracted and, at the same time, the OSNR thereof is measured. Since the second optical packet signal #2′ is an optical packet signal regenerated by the regenerative relay unit 18, the OSNR of the second optical packet signal #2′ is equal to or above the reference value. Hence, the second optical packet signal #2′ is outputted from the first output port 13a, based on the destination information.

As described above, when an optical packet signal whose OSNR is below the reference value is inputted, the optical packet switching apparatus 10 according to the present embodiment, too, can not only switch the route but also regenerate the optical packet signal and output it. As a result, the OSNR of the optical packet signal outputted from the optical packet switching apparatus 10 can be kept at the reference value or above.

Also, the structure according to the present embodiment is such that the regenerated second optical packet signal #2′ is sent back to the optical switch unit 12. Thus, the optical switch unit 12 alone can take care of the congestion handling.

Since the optical packet signal inputted to the fourth input port 11d is an optical packet signal regenerated by the regenerative relay unit 18, the OSNR thereof is equal to or above the reference value. Hence, there is no need to measure the OSNR of the optical packet signals inputted from the fourth input port 11d.

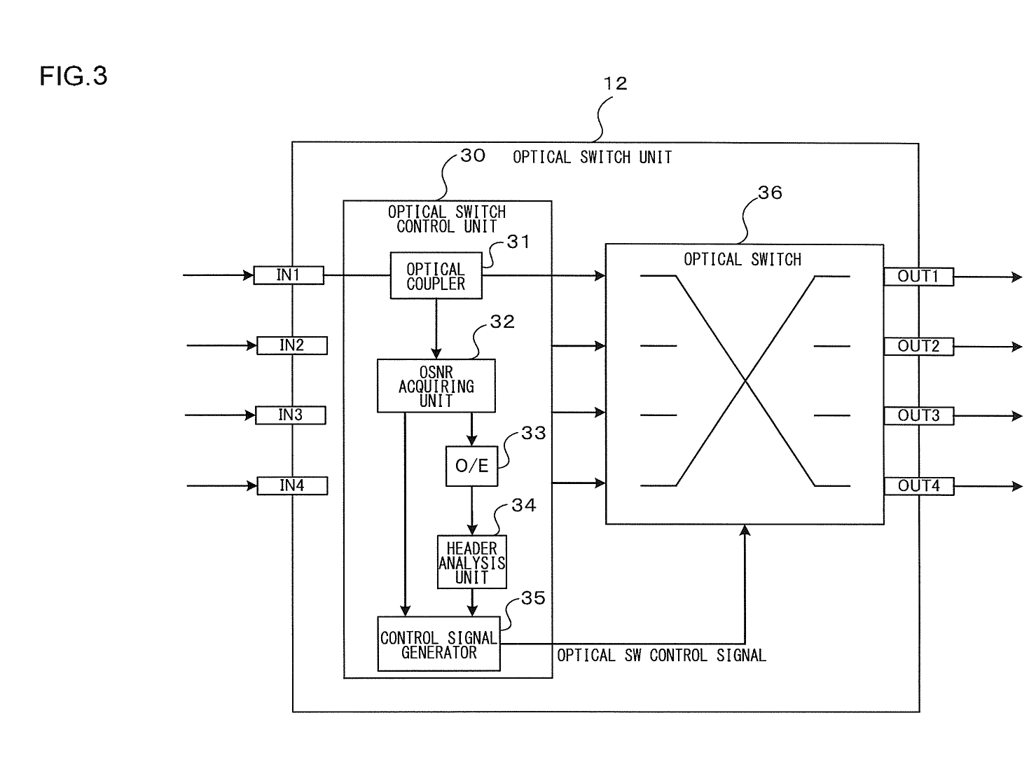

FIG. 3 is a diagram for explaining a structure of an optical switch unit 12. A description is given here of the optical switch unit 12 with four inputs x four outputs. As shown in FIG. 3, the optical switch unit 12 includes first to fourth input ports IN1 to IN4, first to fourth output ports OUT1 to OUT4, an optical switch 36, and an optical switch control unit 30. The optical switch control unit 30 includes an optical coupler 31, an OSNR acquiring unit 32, an optical-to-electrical (O/E) converter 33, a header analysis unit 34, and a control signal generator 35. Though the optical switch control unit 30 is provided for each input port, only a single optical switch control unit 30 corresponding to the first input port IN1 is shown in FIG. 3 for simplicity.

The optical packet signal inputted to the first input port IN1 is inputted to the optical coupler 31 of the optical switch control unit 30. The optical coupler 31 bifurcates the inputted optical packet signal. One of the branched-off optical packet signals is sent to the OSNR acquiring unit 32, whereas the other thereof is sent to the optical switch 36.

The OSNR acquiring unit 32 measures the optical signal-to-noise ratio (OSNR) of the inputted optical packet signal. The information on the OSNR measured is sent to the control signal generator 35. Also, the OSNR acquiring unit 32 sends the optical packet signal to the optical-to-electrical converter 33. The optical-to-electrical converter 33 converts the inputted optical packet signal into an electrical packet signal and then sends the electrical packet signal to the header analysis unit 34. The header analysis unit 34 analyzes the header of the packet signal and extracts the destination information. The thus extracted destination information is sent to the control signal generator 35.

The control signal generator 35 generates a control signal with which to control the optical switch 36, based on the OSNR information and the destination information and then outputs the control signal to the optical switch 36. The optical switch 36 may be implemented as one employing a semiconductor optical amplifier (SOA) gate. The optical switch 36 outputs the optical packet signal from any one of the first to fourth output ports OUT1 to OUT4 by controlling the on/off of an appropriate SOA gate based on an optical switch control signal.

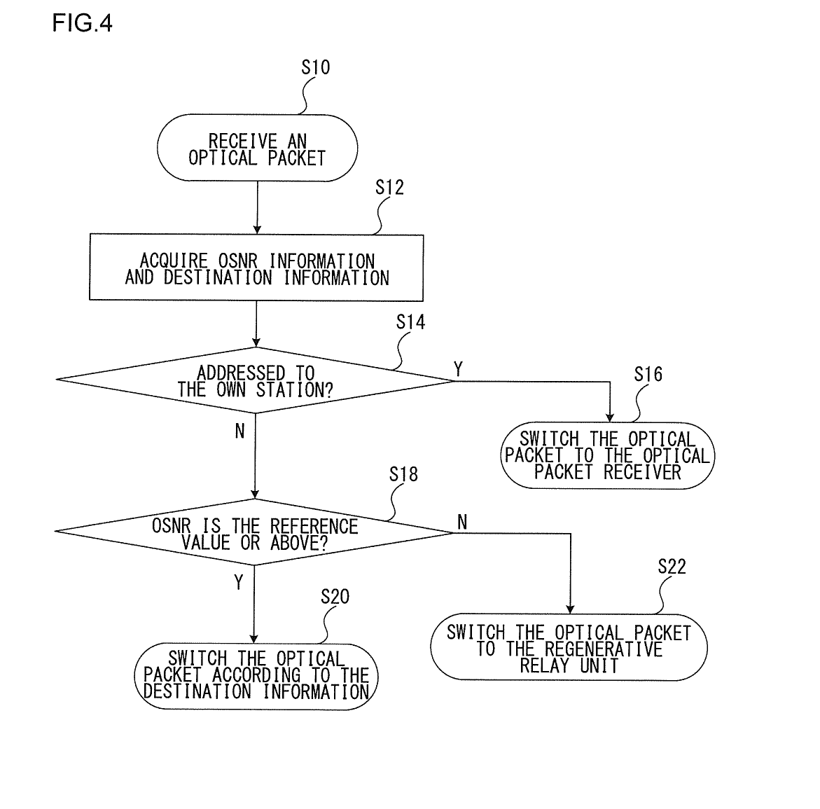

FIG. 4 is a diagram for explaining a processing flow of the optical switch unit 12. As an optical packet signal is received (S10), the OSNR information and the destination information are first obtained by the OSNR acquiring unit 32 and the header analysis unit 34, respectively (S12).

Then, the control signal generator 35 determines whether the received optical packet signal is addressed to its own station or not, based on the destination information (S14).

If the optical packet signal is addressed to its own station (Y of S14), the control signal generator 35 will switch the optical packet signal to the optical packet receiver 16 of its own station (S16). If, on the other hand, the optical packet signal is not addressed to its own station (N of S14), the control signal generator 35 will determine if the OSNR of the optical packet signal is greater than or equal to a predetermined reference value (S18).

If the OSNR thereof is the reference value or above (Y of S18), the control signal generator 35 will switch the optical packet signal according to the destination information (S20). If, on the other hand, the OSNR thereof is less than the reference value (N of S18), the control signal generator 35 will switch the optical packet signal to the regenerative relay unit 18 (S22). As a result, the OSNR of the optical packet signal is improved.

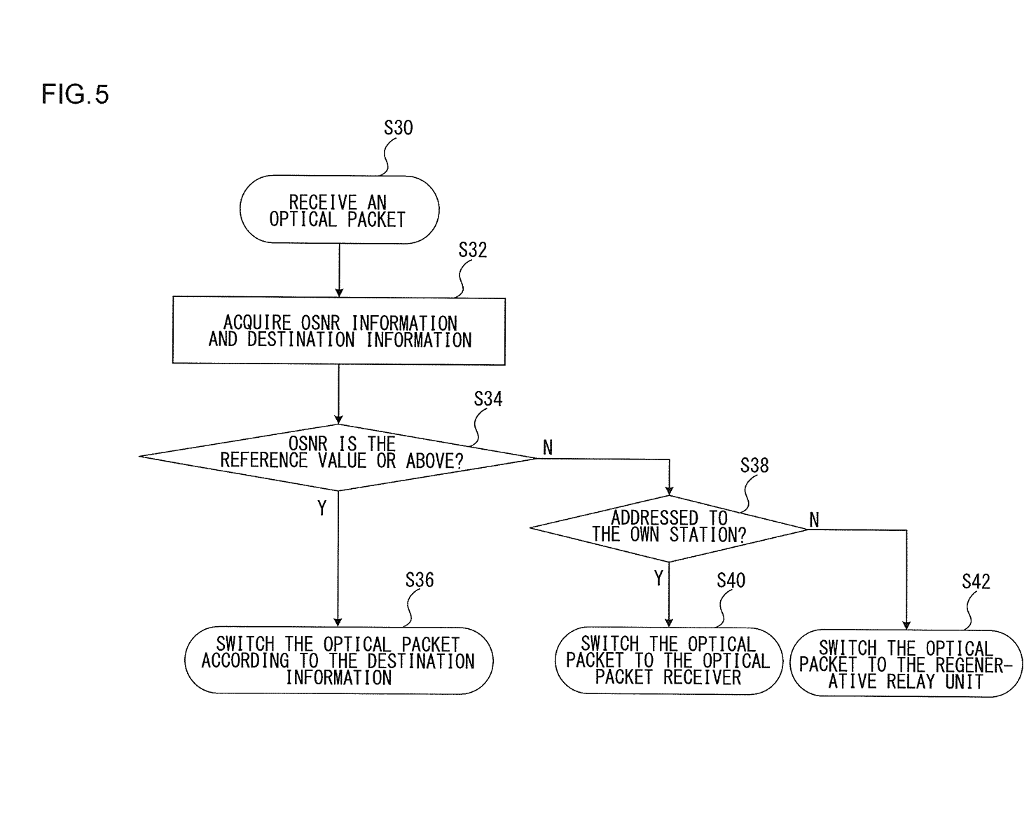

FIG. 5 is a diagram for explaining another processing flow of the optical switch unit 12. As an optical packet signal is received (S30), the OSNR information and the destination information are first obtained by the OSNR acquiring unit 32 and the header analysis unit 34, respectively (S32).

Then, the control signal generator 35 determines if the OSNR of the optical packet signal is greater than or equal to a predetermined reference value (S34).

If the OSNR thereof is the reference value or above (Y of S34), the control signal generator 35 will switch the optical packet signal according to the destination information (S36). If, on the other hand, the OSNR thereof is less than the reference value (N of S34), the control signal generator 35 will determine whether the received optical packet signal is addressed to its own station or not, based on the destination information (S38).

If the optical packet signal is addressed to its own station (Y of S38), the control signal generator 35 will switch the optical packet signal to the optical packet receiver 16 of its own station (S40). If, on the other hand, the optical packet signal is not addressed to its own station (N of S38), the optical packet signal will be switched to the regenerative relay unit 18 (S42). As a result, the OSNR of the optical packet signal is improved.

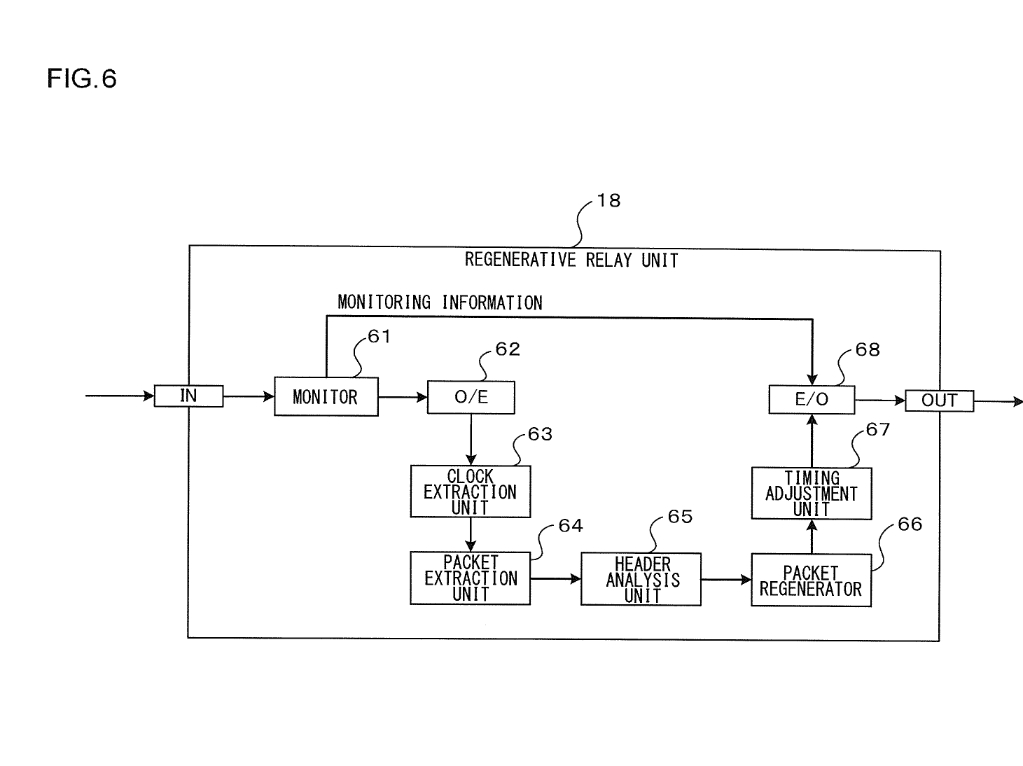

FIG. 6 is a diagram for explaining a structure of the regenerative relay unit 18. As shown in FIG. 6, the regenerative relay unit 18 includes a monitor 61, an optical-to-electrical (O/E) converter 62, a clock extraction unit 63, a packet extraction unit 64, a header analysis unit 65, a packet regenerator 66, a timing adjustment unit 67, and an electrical-to-optical (E/O) converter 68.

An optical packet signal inputted to the regenerative relay unit 18 is inputted to the monitor 61. The monitor 61 monitors the wavelength, the light power and the extinction ratio and the like of the optical packet signal and outputs these pieces of monitoring information to the electrical-to-optical converter 68. Then the optical packet signal is sent to the optical-to-electrical converter 62.

The optical-to-electrical converter 62 converts the optical packet signal into an electrical packet signal and outputs the electrical packet signal to the clock extraction unit 63. The clock extraction unit 63 extracts a clock signal from the inputted packet. The electrical packet signal and the clock signal are inputted to the packet extraction unit 64.

The packet extraction unit 64 extracts a packet from the inputted packet signal, and the header analysis unit 65 analyzes the header of the extracted packet. The packet regenerator 66 identifies and regenerates a packet signal. The timing adjustment unit 67 adjusts the timing with which the regenerated packet signal is outputted to the electrical-to-optical converter 68. The electrical-to-optical converter 68 converts the packet signal into an optical packet signal. Also, the electrical-to-optical converter 68 adjusts the wavelength, the light power, the extinction ratio and the like, based on the monitoring information sent from the monitor 61. The optical packet signal obtained after conversion at the electrical-to-optical converter 68 is sent out from an output port OUT.

The present invention has been described based upon illustrative embodiments. The above described embodiments are intended to be illustrative only and it will be obvious to those skilled in the art that various modifications to the combination of constituting elements and processes could be developed and that such modifications are also within the scope of the present invention.

In the above-described embodiment, for example, the OSNR acquiring unit 32 is provided inside the optical switch unit 12 but it may be provided external to the optical switch unit 12.

What is claimed is:

1. An optical packet switching apparatus comprising:
an optical switch unit configured to switch a route of an inputted optical packet signal;
an optical signal-to-noise ratio (OSNR) acquiring unit configured to acquire information on an optical signal-to-noise ratio of the optical packet signal; and
a regenerative relay unit configured to regenerate and relay the optical packet,
wherein, when the optical signal-to-noise ratio of the optical packet signal is less than a predetermined reference value, the optical switch unit outputs the optical packet signal to the regenerative relay unit.

2. The optical packet switching apparatus according to claim 1, wherein the regenerative relay unit converts the inputted optical packet signal into an electrical signal, performs equalization and amplification, timing extraction, and identification and regeneration on the electrical signal, and again converts the regenerated electrical signal into an optical packet signal so as to be outputted.

3. The optical packet switching apparatus according to claim 1, wherein the regenerative relay unit sends back the regenerated optical packet signal to a route through which the optical packet signal is supposed to be transmitted.

4. The optical packet switching apparatus according to claim 1, wherein the regenerative relay unit sends back the regenerated optical packet signal to an input of the optical switch unit.
